(19) United States
(12) Patent Application Publication
(10) Pub. No.: US 2025/0273696 A1
(43) Pub. Date: Aug. 28, 2025

(54) METHOD FOR MANUFACTURING FUEL CELL CATALYST INK

(71) Applicant: HONDA MOTOR CO., LTD., Tokyo (JP)

(72) Inventors: Takanori IGARASHI, Saitama (JP); Naoki KUSHITANI, Saitama (JP); Shinya SATO, Saitama (JP)

(21) Appl. No.: 19/058,021

(22) Filed: Feb. 20, 2025

(30) Foreign Application Priority Data
Feb. 26, 2024 (JP) 2024-026724

(51) Int. Cl. H01M 4/88; B01D 19/02; H01M 4/86

(52) U.S. Cl. CPC H01M 4/88; B01D 19/02; H01M 4/8663; H01M 2300/0082

(57) ABSTRACT

Provided is a method for manufacturing a fuel cell catalyst ink, which can reduce foaming of the catalyst ink without changing material properties. A method for manufacturing a fuel cell catalyst ink containing a catalyst, an ionomer, and a solvent containing water and an alcohol includes kneading the fuel cell catalyst ink with a bead mill. The solvent has a weight ratio (A/W) of the alcohol A to water W of 0.33 to 3.00. The method further includes defoaming bubbles in the fuel cell catalyst ink after the kneading.

This application is based on and claims the benefit of priority from Japanese Patent Application No. 2024-026724, filed on 26 Feb. 2024, the content of which is incorporated herein by reference.

### BACKGROUND OF THE INVENTION

### Field of the Invention

The present invention relates to a method for manufacturing a fuel cell catalyst ink.

### Related Art

Conventionally, a fuel cell including a membrane-electrode assembly (MEA) configured such that an electrolyte film is sandwiched from both sides by electrodes (air electrode and fuel electrode) formed of a pair of catalyst layers has been used. This polymer electrolyte fuel cell has advantages such as a low operating temperature, a short starting time, and a compact configuration, and has been used in a field of a power source for driving an automobile, or the like.

Each electrode is formed of the catalyst layer, and the catalyst layer contains an electrode catalyst. Such an electrode catalyst causes electrode reactions in the catalyst layer. The catalyst layer is formed of a layer containing a catalyst (also containing catalyst-supported particles supported by a carrier, or the like) and an electrolyte.

In a process for manufacturing the polymer electrolyte fuel cell, each electrode is formed by drying a catalyst ink after the catalyst ink has been directly applied to a surface of a transfer film or a solid polymer electrolyte film. The catalyst ink contains a catalyst, an electrolyte having proton conductivity, and a dispersion solvent in which the catalyst and the electrolyte are dispersed. For example, an ionomer is used as the electrolyte of the catalyst ink, and water and alcohol are generally used for the dispersion solvent. Thus, the catalyst ink contains a considerable amount of water.

As shown in FIG. 5, the ionomer has a hydrophilic group and a hydrophobic group, and micelles M are formed around bubbles B generated in a catalyst ink 10 containing a considerable amount of water. When the micelle M reaches the gas-liquid interface 11 of the catalyst ink 10, the bubble B is stabilized due to the surfactant effect of an electrolyte present at the gas-liquid interface 11, and therefore, the bubble B remains at the gas-liquid interface 11. There have been problems that the electrode reaction in the catalyst layer is interfered by high foaming properties of the ionomer as described above and the performance of the electrode is degraded. For this reason, mechanical defoaming is required for the process for manufacturing the catalyst ink.

However, there has been proposed a technique of eliminating a surfactant effect and reducing generation of bubbles in catalyst ink not by a mechanical defoaming technique but by adding metal ions easily bondable to sulfonic acid which is a hydrophilic group of an ionomer molecule to a suspension containing a catalyst, an electrolyte, and a solvent in a process for manufacturing a catalyst layer (see Japanese Unexamined Patent Application, Publication No. 2019-145254).
Patent Document 1: Japanese Unexamined Patent Application, Publication No. 2019-145254

### SUMMARY OF THE INVENTION

However, in the catalyst ink of Japanese Unexamined Patent Application, Publication No. 2019-145254, an ionomer state greatly contributing to dispersion stability changes, which may degrade dispersion stability in the catalyst ink. Moreover, there has been a problem that the functionality of the ionomer is degraded in proportion to the amount of metal ions added.

An object of the present invention is to provide a method for manufacturing a fuel cell catalyst ink, which can reduce foaming of the catalyst ink without changing material properties.

(1) A method for manufacturing a fuel cell catalyst ink (for example, a catalyst ink 10 described later) according to the present invention is a method for manufacturing a fuel cell catalyst ink containing a catalyst, an ionomer, and a solvent containing water and an alcohol, which includes kneading the fuel cell catalyst ink with a bead mill (for example, bead mill 1 described later).

According to the kneading by the bead mill, the inside of an inner wall of a vessel is filled with the catalyst ink with no gap, and therefore, generation of an gas-liquid interface can be reduced as far as possible, the risk of gas, which is a source of gas for bubbles, being mixed into the catalyst ink can be reduced, and solid-liquid mixing of the catalyst ink is possible.

(2) In the manufacturing method, the solvent has a weight ratio (A/W) of the alcohol A to water W of 0.33 to 3.00.

According to the present manufacturing method, the solid-liquid mixing of the catalyst ink is possible while the generation of bubbles is reduced by the bead mill. When the weight ratio (A/W) of the alcohol A to water W is 0.33 or more, the generation of bubbles can be more effectively reduced in the kneading by the bead mill. When the weight ratio (A/W) of the alcohol A to water W is 3.00 or more, the effect of reducing the generation of bubbles does not change any further. Meanwhile, the amount of the ionomer adsorbed to the catalyst decreases, which leads to problems in that the dispersibility of the catalyst ink is degraded and a combustion risk during drying and an environmental load increase.

(3) The present manufacturing method further includes defoaming the fuel cell catalyst ink to remove bubbles after the kneading.

The method further includes, after the kneading of the catalyst ink according to (1) and (2), the defoaming the catalyst ink to remove bubbles, and therefore, the bubbles in the catalyst ink can be efficiently removed in short time by the simple defoaming.

According to the present invention, by the kneading of the fuel cell catalyst ink by the bead mill, the solid-liquid mixing is possible while the generation of the bubbles is reduced, and an ionomer state greatly contributing to dispersion stability does not change. Thus, the method for manufacturing the fuel cell catalyst ink can be provided, which does not degrade the function of the ionomer.

### BRIEF DESCRIPTION OF THE DRAWINGS

FIG. 1 is a schematic view showing kneading a catalyst ink using a bead mill according to an embodiment;

FIG. 2 is a schematic view showing a conventional step of stirring catalyst ink;

FIG. 3 is a schematic view showing kneading a catalyst ink using a conventional ball mill;

FIG. 4 is a table showing comparison of examples in terms of the presence or absence of bubbles for each weight ratio of alcohol to water according to a kneading technique; and

FIG. 5 is a schematic view showing ionomer foaming properties.

### DETAILED DESCRIPTION OF THE INVENTION

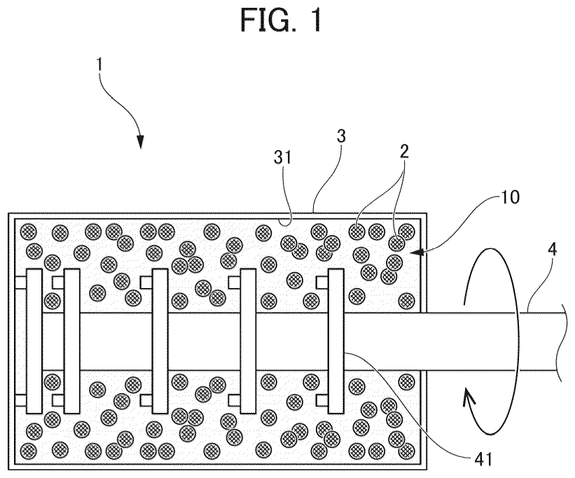

Hereinafter, an embodiment of the present invention will be described in detail with reference to the drawings. As shown in FIG. 1, the solution in the present invention is kneading a catalyst ink 10 using a bead mill 1. The catalyst ink 10 contains a catalyst, an electrolyte having proton conductivity, and a dispersion solvent in which the catalyst and the electrolyte are dispersed. In the present embodiment, an ionomer is used as the electrolyte.

The ionomer to be used here may be a well-known ionomer, and examples thereof include, but are not limited to, perfluorocarbon sulfonic acid polymers often used as an electrolyte material, such as Nafion (registered trademark), sulfonated plastic-based electrolytes such as sulfonated polyetherketone, sulfonated polyether sulfone, sulfonated polyetherethersulfone, sulfonated polysulfone, sulfonated polysulfide, and sulfonated polyphenylene, sulfoalkylated plastic-based electrolytes such as sulfoalkylated polyetheretherketone, sulfoalkylated polyethersulfone, sulfoalkylated polyetherethersulfone, sulfoalkylated polysulfone, sulfoalkylated polysulfide, and sulfoalkylated polyphenylene, and the like.

As the catalyst, catalyst-supported particles supported by a carrier, or the like are used. Catalyst metal may be a well-known catalyst metal, and examples thereof include, but are not limited to, metals such as platinum, ruthenium, iridium, rhodium, palladium, osmium, tungsten, lead, iron, chromium, cobalt, nickel, manganese, vanadium, molybdenum, gallium, and aluminum alone or in combination of two or more types of these materials.

Examples of the carrier supporting the catalyst include, but are not limited to, carbon materials such as carbon black, acetylene black-based carbon black, furnace black-based carbon black, a carbon nanotube, and a carbon nanofiber, carbon compositions such as silicon carbide, and the like. Water and an alcohol-based solvent such as ethanol or 1-propanol may be used as the dispersion solvent, but any type of alcohol may be used as long as an ionomer solution can be dispersed therein.

As shown in FIG. 1, the bead mill 1 includes beads 2, a vessel 3, a rotor 4, a pump (not shown), and a motor (not shown). The beads 2 are a grinding medium, and being vigorously stirred in the vessel 3 by rotating the rotor 4 having received power from the motor (not shown). As the beads, those having a relatively-small diameter are employed. For example, beads with 0.03 mmφ may be used, but the bead diameter can be freely selected depending on the situation. The vessel 3 is a grinding chamber, and is a container for stirring and kneading, inside an inner wall 31 of the vessel 3, the beads 2 and pulverized particles contained in the catalyst ink 10.

The rotor 4 has a disc stirring structure including a plurality of discs 41. Other examples of the rotor stirring structure include a pin-type structure, an annular structure, and the like, and a bead mill of any stirring structure type may be used in the present embodiment. By rotating the rotor 4 at high speed in the vessel 3, the beads 2 having obtained motion energy capture the pulverized particles contained in the catalyst ink 10, and in this manner, the catalyst ink 10 can be dispersed and kneaded.

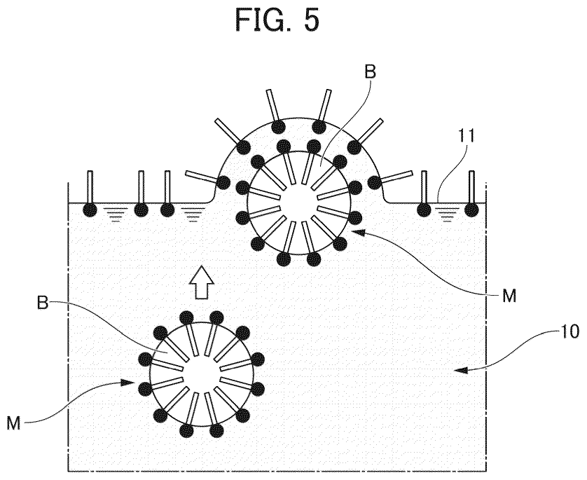

The vessel 3 of the bead mill 1 is filled with the catalyst ink 10 by the pump (not shown), and then, the kneading is performed by the rotor 4. At this time, the inside of the inner wall 31 of the vessel 3 is filled with the catalyst ink 10 as a slurry with no gap, and the catalyst ink 10 is reliably kneaded by the beads 2 and the rotation of the rotor 4. As shown in FIG. 1, the inside of the inner wall 31 of the vessel 3 is filled with the catalyst ink 10 with no gap, and therefore, generation of a gas-liquid interface 11 shown in FIG. 5 can be prevented.

In the kneading by the bead mill 1, the inside of the inner wall 31 of the vessel 3 is filled with the catalyst ink 10 with no gap, and therefore, the generation of the gas-liquid interface 11 can be reduced as far as possible, the risk of gas, which is a source of gas for bubbles B, being mixed into the catalyst ink 10 can be reduced, and solid-liquid mixing of the catalyst ink 10 is possible.

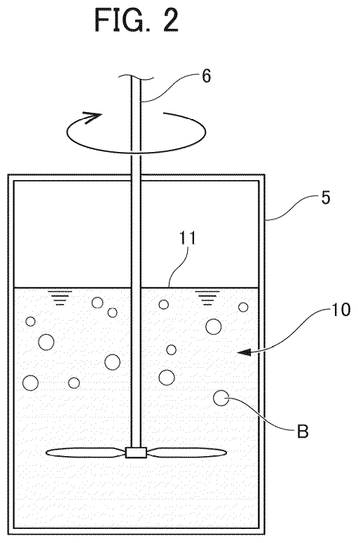

FIG. 2 is a schematic view showing a stirring method by a stir bar. The catalyst ink 10 in a container 5 is stirred by rotation of the propeller-shaped stir bar 6, and there is the gas-liquid interface 11 at the surface of the catalyst ink 10. With the gas-liquid interface 11, gas present in an upper portion in the container 5 is easily mixed with the catalyst ink 10 during the stirring, and the bubbles B are easily generated.

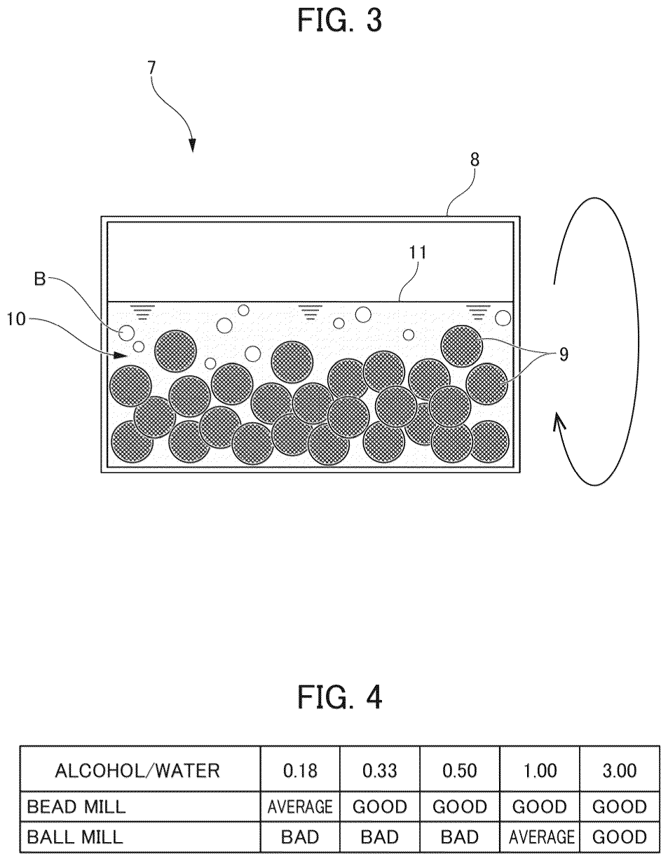

FIG. 3 is a schematic view showing a crushing mechanism using a ball mill. The ball mill 7 includes a ball mill pot 8, balls 9, and biaxial rollers (not shown). The ball mill 7 is a crushing mechanism configured such that the ball mill pot 8 is placed between the biaxial rollers (not shown) such that the longitudinal directions thereof are parallel with each other and the catalyst ink 10 is crushed using collision between the balls 9 by rotating the ball mill pot 8 by drive of the rollers. The gas-liquid interface 11 of the catalyst ink 10 is present inside the ball mill pot 8, and for this reason, gas inside the ball mill pot 8 is easily mixed with the catalyst ink 10 during the crushing and the bubbles B are easily generated as in the above-described stirring method by the stir bar.

As described above, by the fuel cell catalyst ink manufacturing method including the kneading of the catalyst ink 10 by the bead mill 1, an effect of suppressing foaming properties, which are high for the ionomer, and preventing the generation of the bubbles B in the catalyst ink 10 is obtained as compared to the conventional crushing technique. In a case where the bubbles B remain in the ionomer, there are a probability that an adverse effect is caused on crushing force during the kneading, a probability that the quality of a transfer film applied with the ionomer, or the like is degraded, and a probability that the bubbles B rupture during drying and crater-shaped defects remain in the surface of the ionomer due to the rupture.

Further, the bubbles B are generated in the ionomer, and at a bubble rupture location, the ionomer is locally present and forms a film, which may interfere with gas diffusion of a fuel cell. Moreover, due to ionomer segregation in an electrode, the performance of the electrode may be degraded.

### EXAMPLES

Next, the present embodiment will be described in more detail with reference to examples, but is not limited to these examples.

The catalyst ink 10 was kneaded using the bead mill 1 and the ball mill 7, and a comparative test was conducted on whether or not the bubbles B were generated. Specifically, the catalyst ink 10 contains the catalyst, the ionomer as the electrolyte, and water and an alcohol as the dispersion solvent. The alcohol in the dispersion solvent has a well-known ionomer defoaming effect. Thus, as the ratio of the alcohol to water in the dispersion solvent increases, an effect of reducing the bubbles B in the catalyst ink 10 during the kneading is more prominent.

However, while the defoaming effect for the catalyst ink 10 is enhanced, there is, on the other hand, a problem in that the amount of the ionomer adsorbed to the catalyst decreases and the dispersibility of the dispersion solvent decreases as the ratio of the alcohol to water in the solvent of the catalyst ink 10 increases. Moreover, there is not only a risk of the catalyst ink 10 combusting during drying, but also a problem of increasing an environmental load.

On the other hand, in a case where the ratio of water to the alcohol in the solvent is high, the amount of the ionomer adsorbed to the catalyst is improved, and therefore, an effect of improving the dispersibility of the catalyst ink 10 is obtained. When the catalyst ink 10 is applied to the surface of the transfer film or a solid polymer electrolyte film, an effect of improving the coatability of the catalyst ink 10 is expected because the ratio of water to the alcohol in the solvent is high. Thus, in this test, the weight ratios of water and the alcohol forming the dispersion solvent were also targeted for comparison, and the test on the kneading of the catalyst ink 10 was conducted. The presence or absence of the bubbles B after the kneading was visually checked.

FIG. 4 shows results of the test on the kneading of the catalyst ink 10. FIG. 4 shows the weight ratio (A/W) of the alcohol A to water W in the dispersion solvent, and shows the presence or absence of the bubbles B for each weight ratio (A/W). In the table, a case where the bubbles B were not visually confirmed at all after the kneading is shown as “good”, a case where the bubbles B were entirely and clearly visually confirmed is shown as “bad”, and a case where a slight amount of bubbles B was visually confirmed is shown as “average”.

As shown in the table of FIG. 4, no bubbles B were generated in the catalyst ink 10 after the kneading of the catalyst ink 10 by the bead mill 1. However, only a case where the weight ratio (A/W) of the alcohol A to water W is 0.18 showed a result of “average”. It is assumed that as a cause, a slight amount of bubbles B were confirmed because it is impossible to reduce gas inclusion to zero in the experiment.

On the other hand, after the kneading by the ball mill 7, the generation of the bubbles B in the catalyst ink 10 was clearly confirmed within a range of 0.18 to 0.5 in terms of the weight ratio (A/W) of the alcohol A to water W. In a case where the weight ratio (A/W) of the alcohol A to water W is a high ratio of 3.00, the result showing no generation of the bubbles B in the catalyst ink 10 was obtained even after the kneading by the ball mill 7.

These test results showed that no bubbles B are generated in the catalyst ink 10 even after the kneading of the catalyst ink 10 by the ball mill 7 when the weight ratio (A/W) of the alcohol A to water W is a high numerical value of 3.00 or more. However, as the weight ratio (A/W) of the alcohol A to water W increases, the above-described problems become more prominent in the catalyst ink 10. On the other hand, by the kneading by the bead mill 1, the bubbles B generated in the catalyst ink 10 can be reduced even with a high weight ratio of the alcohol A to water W in the dispersion solvent. Thus, the bead mill 1 can perform the kneading of the catalyst ink 10 with the dispersibility of the catalyst ink 10 and without the adverse effect on the catalyst layer.

The process for manufacturing the catalyst ink may include, after the kneading, mechanically defoaming the catalyst ink to remove the bubbles generated therein by, for example, a planetary centrifugal defoaming machine. In the present embodiment, in a case where the catalyst ink 10 is kneaded by the bead mill 1, it is difficult to reduce the gas inclusion to zero during the kneading as described above, and when the kneading is performed with even a slight amount of gas adhering to the beads 2 or the like, gas may be mixed with the catalyst ink 10 due to the micro gas-liquid interface 11 and the bubbles B may be generated. In order to solve such a problem, mechanically defoaming the catalyst ink may be performed after the kneading of the catalyst ink in the present embodiment.

In the present example, in the dispersion solvent of the catalyst ink 10, the weight ratio (A/W) of the alcohol A to water W is preferably within a range of 0.33 to 3.00. When the weight ratio (A/W) of the alcohol A to water W is 0.33 or more, the generation of the bubbles can be more effectively reduced in the kneading by the bead mill. When the weight ratio (A/W) of the alcohol A to water W is 3.00 or more, the effect of reducing the generation of the bubbles does not change any further. Meanwhile, the amount of the ionomer adsorbed to the catalyst decreases, which leads to problems in that the dispersibility of the catalyst ink 10 is degraded and the combustion risk during drying and the environmental load increase.

According to the present embodiment, the following effects are produced.

The kneading of the catalyst ink 10 according to the present embodiment is performed by the bead mill 1.

Thus, the inside of the inner wall 31 of the vessel 3 is filled with the catalyst ink 10 with no gap, and therefore, the generation of the gas-liquid interface 11 can be reduced as far as possible and the generation of the bubbles B in the catalyst ink 10 can be reduced.

In the present embodiment, mechanical defoaming of the catalyst ink 10 may be performed after the kneading of the catalyst ink 10 by the bead mill 1. The generation of the bubbles B has already been reduced as far as possible by the kneading by the bead mill 1, and therefore, the bubbles B in the catalyst ink 10 can be efficiently removed in a short time by simple defoaming.

Thus, the bubbles B generated in the catalyst ink 10 can be fully removed.

In the present embodiment, the dispersion solvent is formed of water and an alcohol, and the weight ratio (A/W) of the alcohol A to water W is preferably within a range of 0.33 to 3.00.

With this configuration, the mechanical defoaming of the catalyst ink 10 can be performed after the kneading of the catalyst ink 10, the cause for the degradation of the catalyst ink 10 due to the alcohol can be eliminated, and the bubbles B generated in the catalyst ink 10 can be fully removed.

The preferred embodiment of the present invention has been described above. However, the present invention is not limited to the embodiment above, and can be changed as necessary within the scope of the gist of the present invention.

### EXPLANATION OF REFERENCE NUMERALS

1 Bead Mill
10 Catalyst Ink (Fuel Cell Catalyst Ink)

What is claimed is:

1. A method for manufacturing a fuel cell catalyst ink containing a catalyst, an ionomer, and a solvent containing water and an alcohol, comprising:
kneading the fuel cell catalyst ink with a bead mill.

2. The method for manufacturing the fuel cell catalyst ink according to claim 1, wherein the solvent has a weight ratio (A/W) of the alcohol A to water W of 0.33 to 3.00.

3. The method for manufacturing the fuel cell catalyst ink according to claim 1, further comprising: defoaming the fuel cell catalyst ink to remove bubbles after the kneading.
